(19) United States
(12) Patent Application Publication
(10) Pub. No.: US 2008/0072785 A1
(43) Pub. Date: Mar. 27, 2008

(54) Method For Grinding Mineral Materials In The Presence Of Thickening Agents, Resulting Aqueous Suspensions And Uses Thereof

(75) Inventors: Jean-Marc Suau, Lucenay (FR); Denis Ruhlmann, Genay (FR); Christian Jacquemet, Lyon (FR); Jacques Mongoin, Quincieux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COATEX S.A.S., Genay (FR)

(21) Appl. No.: 11/632,285

(22) PCT Filed: Jul. 5, 2005
(86) PCT No.: PCT/FR05/01716

§ 371 Date: Feb. 9, 2007

(30) Foreign Application Priority Data
Jul. 13, 2004 (FR) 0407803

(51) Int. Cl. C04B 14/02; B01F 3/12; C09D 11/02; B02C 23/00

(52) U.S. Cl. 106/31.9; 106/401; 106/417; 106/425; 106/436; 106/461; 106/464; 106/482; 106/484; 106/501.1; 241/21; 516/78

(57) ABSTRACT

The invention concerns a process of grinding of mineral matter in water, in the presence of thickening agents, the stable suspensions of mineral matter ground in water obtained by the process according to the invention, and the use of the said suspensions in aqueous formulations, in particular formulations of linings such as aqueous paints, renderings, inks, coatings, sealants, adhesives, glues, and other aqueous formulations incorporating mineral matter. Finally, the invention concerns the aqueous formulations obtained according to the invention.

The present invention concerns the field of aqueous suspensions of ground mineral matter and its uses in aqueous formulations.

The invention firstly concerns a process for grinding of mineral matter in water, in the presence of thickening agents.

The invention also concerns stable suspensions of mineral matter ground in water and obtained by the process according to the invention.

The invention also concerns the use of the said suspensions in aqueous formulations, particularly formulations of linings such as notably aqueous paints, renderings, inks, coatings, sealants, adhesives, glues, and other aqueous formulations incorporating mineral matter.

Finally, the invention concerns the aqueous formulations obtained according to the invention.

In order to adapt the rheology of his product to conditions of application as varied as the nature of the surface to be covered, the means of application, the quantity of product to be applied and, independently, to give this product satisfactory stability, the skilled man in the art currently has a very wide range of additives available, commonly called “thickening agents”. These thickening agents develop complex interactions with the other constituents present in the paint formulations, interactions which have formed the subject of many works for more than half a century: the goal of this research remains to better apprehend the operating mechanism of these rheological additives, in order to give the skilled man in the art tools and rules suitable for choosing the correct thickening agent, in accordance with the desired rheology and with the other constituents present in the paint formulation.

In the course of these works, a very special focus has been applied to the interactions which the thickening agents can develop with aqueous suspensions of mineral fillers stabilised with the aid of dispersing agents. This interest is justified by the fact that the mineral filler, such as titanium dioxide or calcium carbonate, which was previously contributed in the form of dry powder, is now contributed in the form of aqueous suspensions: the latter are, indeed, simpler to use, eliminate problems relating to the use of powdery materials, and facilitate filler handling operations by simple pumping of the said suspensions.

The interactions between thickening agents and dispersing agents contained in aqueous suspensions of mineral matter are described in the document “Rheology of associative thickener pigment and pigmented commercial latex dispersions” (Progress in Organic Coatings, 17, (1989), pp. 155-173) which envisages the case of an aqueous suspension of titanium dioxide, dispersed by polymethacrylic acid and put in the presence of different thickening agents. It then appears that for a growing concentration of dispersing agent, certain thickening agents of the HEUR (Hydrophobe-modified Ethoxylated Urethane) type lead to a destabilisation of the titanium dioxide, whereas the stability of the suspension is maintained in the presence of cellulosic thickening agents.

In addition, these works have also demonstrated that the interactions between dispersing agents and thickening agents may influence the end properties of the paint film, such as the brightness. In this respect, “Pigment stabilization through mixed associative thickener interactions” (Journal of Coatings Technology, 64, 807, (1992), pp. 53-61) teaches that the use of a thickening agent of the HEUR type (Hydrophobe-modified Ethoxylated Urethane) in combination with a dispersing agent which is a copolymer of maleic acid and diisobutylene leads to an increase in the brightness in the case of latex paints. Conversely, “Interactions between rheology-modifying and pigment-dispersing agents” (Farbe+Lack, 100, 9, (1994), pp. 759-764) demonstrates that paint formulations containing thickening agents of the HEUR type (Hydrophobe-modified Ethoxylated Urethane) and dispersing agents with a highly ionic character can reduce the brightness of the end product. The authors of these works discuss the possible combinations between different dispersing agents and thickening agents of the HEUR type (Hydrophobe-modified Ethoxylated Urethane) and HASE type (Hydrophobically modified Alkali-swellable Emulsions).

To summarise, the general teaching of these documents for the skilled man in the art is that the interactions between dispersing agents and thickening agents are complex, and determine both the stability of the formulated paint and the properties of the end paint film. This situation is summarised by the document “Adsorption studies of associative interactions between thickener and pigment particles” (Progress in organic coatings, 30, (1997), pp. 161-171): the skilled man the art is strongly encouraged to select attentively new combinations of dispersing agents and thickening agents to exploit their potential (pp 167 introduction), in terms of the stability of the paint thus manufactured and of end properties of the paint film.

In addition, continuing to use mineral fillers in the form of aqueous suspensions, the skilled man in the art has sought to develop intermediate products which consist of simple blends of different constituents of paint, the formulation of the said paint then amounting to the assembly of the different constituents, by simple blending. In this respect, it is known to manufacture aqueous suspensions of mineral matter containing water, a mineral filler and a thickening agent. These suspensions are intended to be blended subsequently with other habitual constituents of a paint to obtain the desired end product.

Thus, the skilled man in the art is familiar with document US 2002 050228, which describes the preparation of an aqueous suspension containing calcium carbonate and a pigment such as titanium dioxide. Such a composition can also contain a thickening agent, and be used in the formulation of inks and aqueous paints.

He is also familiar with document U.S. Pat. No. 6,074,474, which describes an aqueous suspension containing mineral particles having a particular granulometric distribution, and which may be calcium carbonate. In addition, such a suspension may contain a thickening agent and be used subsequently in the formulation of aqueous paints.

Thus, pursuing his research with a view to producing stable suspensions of mineral matter in the presence of thickening agents, whilst eliminating the use of dispersing agents which can lead to prejudicial effects in terms of the rheology of the end product (by interaction with the thickening agents), the Applicant has found in a surprising manner a new process of manufacture of an aqueous suspension of mineral fillers, characterised in that the said mineral fillers are ground in water in the presence of thickening agents. The product thus obtained has a stability completely compatible with its use in aqueous formulations.

At this stage, the Applicant wishes to stress that the present invention is distinguished from the previously cited prior art by the fact that the said prior art neither reveals nor teaches the grinding process leading to the diminution of the size of the mineral particles.

In addition, the suspension thus manufactured responds to the wish of the skilled man in the art in the sense that it gives him a product which already contains a part of the thickening agent used in paint. Secondly, and in a completely surprising manner, the said thickening agents are not degraded in the course of the grinding process, and fulfil, precisely at this stage of the manufacture, the function of grinding aid agents, thereby allowing a reduced consumption of grinding aid agents: the Applicant has, indeed, observed a notable reduction of the size of the particles of mineral matter. And it is well known that the possibility of choosing the size of the mineral particles, in the context of the formulation of a paint, is of great importance for the skilled man in the art. Indeed, the size of the particles greatly influences the mechanical and optical properties of the end film, as taught in “Particle-size distribution of fillers and their importance in the preparation of paints” (Deutsche Farben-Zeitschrift, 20 (12), 1966, pp. 565-567). In addition, the process according to the invention allows the use of a very large range of commercially available thickening agents for paints.

The process according to the invention also enables aqueous suspensions of mineral matter to be obtained which, when used in paint formulations, enable paint formulations to be produced having rheological properties which are improved relative to those of the prior art, notably by having increased ICI and Stormer viscosities. These improved rheological properties also have the advantage of leading to an improved quality of application of the paint.

Finally, the property of the thickening agent as such are preserved, since the optical properties of the paint film produced according to the invention are not degraded, and nor are the pigmentary compatibility properties of the paints thus formulated.

The invention therefore enables aqueous paint formulations which are stable over time to be obtained, without using dispersing agents. In addition, the invention enables an intermediate product to be obtained in the form of an aqueous suspension of mineral matter and thickening agents, where the latter also play the role of grinding aid agents. In this regard, in the course of this process, it is possible to continue to use “traditional” grinding aid agents. Finally, the aqueous suspension thus obtained by grinding of mineral matter in water and in the presence of thickening agents has a stability which is perfectly compatible with its use in the formulation of aqueous paints.

The object of the invention is therefore a process for grinding of mineral matter in water, in the presence of thickening agents.

Another object of the invention lies in the stable suspensions of mineral matter ground in water and obtained according to the said process.

Another object of the invention is the use of the said suspensions in aqueous formulations, particularly formulations of linings such as notably aqueous paints, renderings, inks, coatings, sealants, adhesives, glues, and other aqueous formulations incorporating mineral matter.

A final object of the invention lies in the aqueous formulations obtained according to the invention.

The process according to the invention therefore enables aqueous suspensions of mineral matter to be obtained, without using dispersing agents, and having a rheology compatible with their use in aqueous formulations.

In addition, the process according to the invention also enables aqueous suspensions of mineral matter to be obtained which, when used in paint formulations, enable paint formulations to be produced having rheological properties which are improved relative to those of the prior art, notably by having increased ICI and Stormer viscosities.

This process also enables products to be manufactured in accordance with the requirements of the skilled man in the art: they contain water, one or more mineral fillers, and at least one thickening agent.

It also enables the fineness of the mineral matter used to be adjusted by grinding it in the presence of thickening agents: the latter, in this respect, fulfil the function of grinding aid agents.

In addition, the thickening agents are not degraded in the course of the grinding process, and the optical properties of the paint film are not impaired, and nor are the pigmentary compatibility properties of the paints thus formulated. Finally, the aqueous suspensions of mineral matter ground in this manner and stable over time are used in the formulation of aqueous paints having a very satisfactory stability, and improved rheological properties.

These aims are attained through a new process of manufacture of a stable suspension of mineral matter in water, characterised in that the said mineral matter is ground in the presence of thickening agents.

The Applicant wishes to stipulate that the operation to grind the mineral substance to be refined consists in grinding the mineral substance with a grinding body into very fine particles in an aqueous medium containing the thickening agents.

Thus, the thickening agents and the grinding body, of granulometry advantageously of between 0.20 and 4 millimetres, are added to the aqueous suspension of the mineral substance for grinding. The grinding body generally has the form of particles of materials as diverse as silicon dioxide, aluminium oxide, zirconium oxide or blends thereof, together with synthetic resins of great hardness, steels or other. An example of the composition of such grinding bodies is given by patent FR 2 203 681 which describes the grinding elements formed 30% to 70% by weight of zirconium oxide, 0.1% to 5% of aluminium oxide, and 5 to 20% of silicon dioxide.

The grinding body is preferably added to the suspension in a quantity such that the ratio by weight between this grinding material and the mineral substance for grinding is at least 2/1, this ratio being preferably between the limits 3/1 and 5/1.

The blend of the suspension and the grinding body is then subjected to the mechanical stirring action, as occurs in a traditional grinder with micro-elements.

The time required to attain the desired refinement of the mineral substance after grinding will be defined by the manufacturer of suspensions of mineral matter according to the nature and quantity of the mineral substances to be ground, and according to the stirring method used and the temperature of the medium during the grinding operation.

Another variant of the process is characterised in that the said process uses at least one grinding aid agent. The said agent will be chosen by the manufacturer of suspensions of mineral matter from among all the grinding aid agents well known to them, and their blends.

The process according to the invention is also characterised in that the mineral matter is a pigment and/or a mineral filler, chosen from among natural or synthetic calcium carbonate, the dolomites, kaolin, talc, gypsum, lime, magnesia, titanium dioxide, satin white, aluminium trioxide, or again aluminium trihydroxide, mica, zinc and iron oxides, barium sulphate and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends.

Preferentially, the mineral matter is synthetic or natural calcium carbonate, titanium dioxide, or their blends.

More preferentially, the mineral matter is a synthetic calcium carbonate or a natural calcium carbonate chosen from among marble, calcite, chalk or their blends.

The process according to the invention is also characterised in that the thickening agents are chosen from among the natural thickening agents, such as the natural gums, the CMCs (Carboxymethylcelluloses) and the HECs (Hydroxyethylcelluloses) or the synthetic thickening agents, such as the synthetic gums, the acrylic thickening agents of the HASE type (Hydrophobically modified Alkali-swellable Emulsions) or ASE type (Alkali Soluble Emulsions), polyurethanes, polyethers, polyesters or those having a PVP (polyvinylpyrrolidone) base.

Preferentially, the thickening agents are chosen from among the acrylic thickening agents of the HASE type (Hydrophobically modified Alkali-swellable Emulsions) and the polyurethane thickening agents.

The process according to the invention is also characterised in that at least 15% by dry weight of mineral matter relative to the total weight of the aqueous suspension, 0.01% to 5% by dry weight of thickening agents relative to the total weight of the aqueous suspension, and 0 to 5% by dry weight of grinding aid agents relative to the total weight of the aqueous suspension are used.

Preferentially, the said process is characterised in that at least 30% by dry weight of mineral matter relative to the total weight of the aqueous suspension, 0.5% to 1.5% by dry weight of thickening agents relative to the total weight of the aqueous suspension, and 0 to 2% by dry weight of grinding aid agents relative to the total weight of the aqueous suspension are used.

Even more preferentially, the said process is characterised in that at least 50% by dry weight of mineral matter relative to the total weight of the aqueous suspension, 0.5% to 1.5% by dry weight of thickening agents relative to the total weight of the aqueous suspension, and no grinding aid agent, are used.

Another object of the invention lies in the aqueous suspensions of mineral matter ground in the presence of thickening agents obtained by the process according to the invention, and characterised in that they contain at least 15% by dry weight of mineral matter relative to the total weight of the aqueous suspension, 0.01% to 5% by dry weight of thickening agents relative to the total weight of the aqueous suspension, and 0 to 5% by dry weight of grinding aid agents relative to the total weight of the aqueous suspension.

Preferentially, the said suspensions of mineral matter are characterised in that they contain at least 30% by dry weight of mineral matter relative to the total weight of the aqueous suspension, 0.5% to 1.5% by dry weight of thickening agents relative to the total weight of the aqueous suspension, and 0 to 2% by dry weight of grinding aid agents relative to the total weight of the aqueous suspension.

Even more preferentially, the said suspensions of mineral matter are characterised in that they contain at least 50% by dry weight of mineral matter relative to the total weight of the aqueous suspension, 0.5% to 1.5% by dry weight of thickening agents relative to the total weight of the aqueous suspension, and no grinding aid agents.

The aqueous suspensions of mineral matter obtained by the process according to the invention are also characterised in that they have a granulometry such that at least 50% of the particles of mineral matter have a diameter less than or equal to 30 μm, i.e. a median diameter d₅₀ less than or equal to 30 μm.

Throughout the present application, the granulometry of the suspensions is determined using a Mastersizer™ 2000 granulometer sold by the company MALVERN™. Preferentially, the aqueous suspensions of mineral matter obtained by the process according to the invention are also characterised in that they have a granulometry such that at least 50% of the particles of mineral matter have a diameter of less than or equal to 15 μm.

Even more preferentially, the aqueous suspensions of mineral matter obtained by the process according to the invention are also characterised in that they have a granulometry such that at least 50% of the particles of mineral matter have a diameter of less than or equal to 10 μm.

Finally, extremely preferentially, the aqueous suspensions of mineral matter obtained by the process according to the invention are also characterised in that they have a granulometry such that at least 50% of the particles of mineral matter have a diameter of less than or equal to 5 μm.

The said aqueous suspensions are also characterised in that the mineral matter is a pigment and/or a mineral filler, chosen from among natural or synthetic calcium carbonate, the dolomites, kaolin, talc, gypsum, lime, magnesia, titanium dioxide, satin white, aluminium trioxide, or again aluminium trihydroxide, mica, zinc and iron oxides, barium sulphate and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends.

Preferentially, the mineral matter is synthetic or natural calcium carbonate, titanium dioxide, or their blends.

More preferentially, the mineral matter is a synthetic calcium carbonate or a natural calcium carbonate chosen from among marble, calcite, chalk or their blends.

The aqueous suspensions of mineral matters according to the invention are also characterised in that the thickening agents are chosen from among the natural thickening agents, such as the natural gums, the CMCs (Carboxymethylcelluloses) and the HECs (Hydroxyethylcelluloses) or the synthetic thickening agents, such as the synthetic gums, the acrylic thickening agents of the HASE type (Hydrophobically modified Alkali-swellable Emulsions) or ASE type (Alkali Soluble Emulsions), polyurethanes, polyethers, polyesters or those having a PVP (polyvinylpyrrolidone) base.

Preferentially, the aqueous suspensions of mineral matter according to the invention are also characterised in that the thickening agents are chosen from among the acrylic thickening agents of the HASE type (Hydrophobically modified Alkali-swellable Emulsions) and the polyurethane thickening agents.

Another object of the invention is the use of the said suspensions in aqueous formulations, particularly formulations of linings such as notably aqueous paints, renderings, inks, coatings, sealants, adhesives, glues, and other aqueous formulations incorporating mineral matter.

A final object of the invention lies in the aqueous formulations obtained according to the invention.

Thus, the aqueous paints, renderings, inks, coatings, sealants, adhesives, aqueous formulations incorporating mineral matter and glues according to the invention are characterised in that they contain the mineral aqueous suspensions according to the invention ground in the presence of thickening agents.

The following examples illustrate the invention without however limiting its scope.

### EXAMPLE 1

This example concerns the manufacture of aqueous suspensions of mineral matter through a grinding process according to the invention, in the presence of a thickening agent (tests n° 1 to 5), and in the presence of a thickening agent and a traditional grinding aid agent (test n° 6). It also concerns the suspensions of mineral matter thus obtained, from the grinding process according to the invention.

In tests n° 1 to 6, a calcium carbonate is used which is a marble from Avenza (Italy), and which has an initial median diameter noted d₅₀ equal to 10 μm (50% of the calcium carbonate particles have a diameter less than or equal to 10 μm). It is sold by the company OMYA™ under the name Omyacarb™ 10 AV.
grinder of the Dyno_Mill™ type with a fixed cylinder and rotating pulser is used, the grinding body of which is constituted by zirconium-based balls of diameter in the range 0.6 millimetre to 1 millimetre.
The total volume occupied by the grinding body is 1000 cubic centimetres, while its mass is 2,700 g.
The grinding chamber has a volume of 1400 cubic centimetres.
The circumferential speed of the grinder is 10 metres per second.
The pigment suspension is recycled at a rate of 40 litres per hour.
The outlet of the Dyno-Mill™ grinder is fitted with a 200 micron mesh separator enabling the suspension resulting from the grinding and the grinding body to be separated.
The temperature during each grinding test is maintained at approximately 30° C.

One starts by blending in the water the dry powder of calcium carbonate with the thickening agent; the blend is then ground using the previously described device. The grinding time is appropriate for the desired granulometry.

Subsequently, the granulometry of the suspensions is determined as follows.

After grinding, a sample of the pigmentary suspension, the granulometry of which is measured using a Mastersizer™ 2000 granulometer sold by the company MALVERN™, is recovered in a flask. The following is then determined:

median diameter d₅₀ of the particles of calcium carbonate thus refined.

The Brookfield™ viscosity of the suspensions is determined as follows.

The Brookfield™ viscosity of the suspension is measured using a Brookfield™ viscometer of type RVT, in the non-stirred flask, at a temperature of 25° C. and at two speeds of rotation of 10 and 100 revolutions per minute with the appropriate moving part. The reading is taken after 1 minute's rotation. 2 Brookfield™ viscosity measurements are obtained, noted respectively μ₁₀ and μ₁₀₀.

After one minute's stirring of the flask which has been at rest for 8 days, the Brookfield™ viscosity of the suspension is measured using the same method.

Test n° 1

This test illustrates the invention and uses 0.64% by dry weight relative to total weight of the suspension, of an acrylic thickening agent sold by the company COATEX™ under the name Rheo 2000™. It also uses 64.6% by dry weight relative to the total weight of the suspension of calcium carbonate from Avenza, and the remainder of water.

Test n° 2

This test illustrates the invention and uses 0.60% by dry weight relative to total weight of the suspension, of an acrylic thickening agent sold by the company COATEX™ under the name Rheo 2000™. It also uses 60.0% by dry weight relative to the total weight of the suspension of calcium carbonate from Avenza, and the remainder of water.

Test n° 3

This test illustrates the invention and uses 0.37% by dry weight relative to the total weight of the suspension, of a thickening agent which is a cellulosic ether sold by the company AQUALON™ under the name Natrosol™ 250 HHR. It also uses 52.6% by dry weight of calcium carbonate from Avenza, relative to the total weight of the suspension, and the remainder of water.

Test n° 4

This test illustrates the invention and uses 0.61% by dry weight relative to total weight of the suspension of a polyurethane thickening agent of the HEUR type sold by the company COATEX™ under the name COAPUR™ 3025. It also uses 61.0% by dry weight of calcium carbonate from Avenza, relative to the total weight of the suspension, and the remainder of water.

Test n° 5

This test illustrates the invention and uses 0.51% by dry weight relative to total weight of the suspension, of a polyurethane thickening agent of the HEUR type sold by the company COATEX™ under the name COAPUR™ 3025. It also uses 51.5% by dry weight of calcium carbonate from Avenza, relative to the total weight of the suspension, and the remainder of water.

Test n° 6

This test illustrates the invention and uses 0.50% by dry weight relative to total weight of the suspension, of an acrylic thickening agent sold by the company COATEX™ under the name Rheo 2000™. It also uses 56.7% by dry weight of calcium carbonate from Avenza, relative to the total weight of the suspension. It also uses 0.3% by dry weight relative to the total weight of the suspension, of a grinding aid agent which is sodium polyacrylate, and the remainder of water.

The characteristics of the suspensions obtained from tests n° 1 to n° 6 are shown in table 1.

TABLE 1
characteristics of the aqueous suspensions of calcium
carbonate ground according to the invention.

| | | Invention | | | | | |
|---|---|---|---|---|---|---|---|
| Test n° | | 1 | 2 | 3 | 4 | 5 | 6 |
| CaCO3 (% by dry weight) | | 64.6 | 60.0 | 52.6 | 61.0 | 51.5 | 56.7 |
| Thickening agent | | 0.64 | 0.60 | 0.37 | 0.61 | 0.51 | 0.50 |
| (% by dry weight) | | | | | | | |
| Grinding aid agent | | 0 | 0 | 0 | 0 | 0 | 0.30 |
| (% by dry weight) | | | | | | | |
| d₅₀ (μm) | | 4.9 | 2.0 | 4.7 | 5.2 | 2.3 | 5.3 |
| Viscosity | μ₁₀ (mPa · s) | 2550 | 4740 | 4540 | 4720 | 8800 | 3360 |
| at T = 0 | μ₁₀₀ (mPa · s) | 1580 | 1550 | 1240 | 960 | 1420 | 2210 |
| Viscosity | μ₁₀ (mPa · s) | 1720 | 3880 | 4720 | 6650 | 8250 | 1400 |
| at T = 8 | μ₁₀₀ (mPa · s) | 930 | 1090 | 1470 | 1195 | 2250 | 910 |
| days | | | | | | | |

The percentages by dry weight are understood as relative to the total weight of the suspension.
d₅₀ designates the median diameter of the calcium carbonate particles after grinding (50% of the particles have a diameter of less than this value).
T = 0 designates the initial time at which the Brookfield ™ viscosities at 10 and 100 revolutions per minute are measured, noted respectively μ₁₀ and μ₁₀₀.
T = 8 days designates the time t = 8 days, at which the Brookfield ™ viscosities at 10 and 100 revolutions per minute are measured after stirring, noted respectively μ₁₀ and μ₁₀₀.

The median diameters corresponding to the tests n° 1 to n° 6 demonstrate that, for the process according to the invention, the thickening agents used do indeed act as grinding aid agents, in the sense that a notable diminution of the size of the calcium carbonate particles is observed.

Finally, it is observed that each suspension obtained according to the invention is stable over time.

### EXAMPLE 2

This example concerns the manufacture of aqueous paints according to the invention, from aqueous suspensions of calcium carbonate ground in the presence of thickening agents according to the invention, or from dry powders of calcium carbonate according to the prior art.

The paints are formulated by blending the different constituents, using processes well known to the skilled man in the art. The Applicant indicates that, in the following tests, they have indicated only the nature of the carbonates and thickening agents used. Paints contain, of course, a large number of other additives. The complete list of the constituents of each paint, together with their proportions, are shown in the summary tables.

For each formulated paint, its ICI™, Stormer™ and Brookfield™ viscosities are determined using the following methods.

The ICI™ viscosity is determined in a cone-plane viscometer, known as an ICI™ viscometer, sold by the company ERICHSEN™, using the method well known to those skilled in the art. The measurement is made at 25° C. and is noted pt (P).

The Stormer™ viscosity is determined in a Stormer™ viscometer of type KU-1 sold by the company Brookfield™, fitted with a single measuring system. The measurement is made at 25° C. and is noted μ^{S} (K.U).

The Brookfield™ viscosity of the paints is determined at 25° C. in the same manner as that indicated for example 1 in the case of the suspensions of mineral matter. It is noted μ^{B}₁₀ (mPa·s) and μ^{B}₁₀₀ (mPa·s), depending on whether it is determined at 10 or 100 revolutions per minute.

Test n° 7

This test concerns the formulation of a matt paint, according to the prior art, into which the carbonate is introduced solely in the form of a dry powder.

This is a blend of 2 calcium carbonates which is marble from Avenza (Italy), one having a median diameter of 5 μm (50% of the particles have a diameter of less than 5 μm) and the other a median diameter of 2 μm. They are sold by the company OMYA™ under the respective names Omyacarb™ 5-AV and Omyacarb™ 2-AV. The thickening agent used is an acrylic thickening agent sold by the company COATEX™ under the name Rheo 2000™.

Test n° 8

This test concerns the formulation of a matt paint, according to the invention.

A part of the calcium carbonate is introduced in the form of a dry powder: this is a calcium carbonate which is marble from Avenza (Italy), with a median diameter of 5 μm. It is sold by the company OMYA™ under the name Omyacarb™ 5-AV. The other part is introduced in the form of an aqueous suspension according to the invention and described in test n° 1.

Test n° 9

This test concerns the formulation of a matt paint, according to the invention.

A part of the calcium carbonate is introduced in the form of a dry powder: this is a calcium carbonate which is marble from Avenza (Italy), with a median diameter of 2 μm. It is sold by the company OMYA™ under the name Omyacarb™ 2-AV.

The other part is introduced in the form of an aqueous suspension according to the invention and described in test n° 2.

Test n° 10

This test concerns the formulation of a matt paint, according to the invention.

A part of the calcium carbonate is introduced in the form of a dry powder: this is a blend of 2 calcium carbonates which is marble from Avenza (Italy), one having a median diameter of 5 μm (50% of the particles have a diameter of less than 5 μm) and the other a median diameter of 2 μm. They are sold by the company OMYA™ under the respective names Omyacarb™ 5-AV and Omyacarb™ 2-AV.

The other part is introduced in the form of 2 aqueous suspensions according to the invention and described in tests n° 1 and n° 2.

The list of the constituents and their proportions by weight are indicated in table 2, for the paints corresponding to tests n° 7 to n° 10.

For the paints corresponding to these 4 tests, the skilled man in the art worked with a constant mass of each constituent: as such, the mass of calcium carbonate is identical for these tests, and equal to 500 g; that of the thickening agent is identical and equal to 20 g.

TABLE 2
composition of paints formulated according to tests 7 to 10.

| | Test n° 7 | Test n° 8 | Test n° 9 | Test n° 10 |
|---|---|---|---|---|
| Constituents | (Prior Art) | (Invention) | (Invention) | (Invention) |
| Suspension of carbonate | 0 | 466.1 | 0 | 233.1 |
| ground according to test | | | | |
| n° 1 | | | | |
| Suspension of carbonate | 0 | 0 | 333.3 | 166.7 |
| ground according to test | | | | |
| n° 2 | | | | |
| Omyacarb ™ 5-AV | 300.0 | 0 | 300.0 | 150.0 |
| Omyacarb ™ 2-AV | 200.0 | 200.0 | 0 | 150.0 |
| Tiona ™ RL 68 | 80.0 | 80.0 | 80.0 | 80.0 |
| Water (added in addition) | 209.3 | 54.5 | 83.4 | 68.6 |
| Rheo 2000 ™ | 20.0 | 10.0 | 13.3 | 11.7 |
| Coatex ™ P90 | 4.0 | 4.0 | 4.0 | 4.0 |
| Mergal ™ K6N | 2.0 | 2.0 | 2.0 | 2.0 |
| Nopco ™ NDW | 2.0 | 2.0 | 2.0 | 2.0 |
| Butyldiglycol | 10.0 | 10.0 | 10.0 | 10.0 |
| White Spirit | 10.0 | 10.0 | 10.0 | 10.0 |
| Ammonia | 2.7 | 1.4 | 2.0 | 1.7 |
| Acronal ™ 290 D | 160.0 | 160.0 | 160.0 | 160.0 |
| Total | 1000.0 | 1000.0 | 1000.0 | 1000.0 |

The figures designate masses by weight.
Tiona ™ RL 68 designates titanium dioxide sold by the company MILLENNIUM ™
Coatex ™ P90 is a polyacrylic dispersing agent sold by the company COATEX ™
Mergal ™ K6N is a bactericide sold by the company TROY ™
Nopco ™ NDW is an anti-foaming agent sold by the company COGNIS ™
Acronal ™ 290 D is an acrylic binder sold by the company BASF ™

The values of the ICI™, Stormer™ and Brookfield™ viscosities, measured at different times, for the paints formulated in tests 7 to 10, are summarised in table 2 b.

TABLE 2 b
viscosities measured in relation to paints formulated
according to tests n° 7 to n° 10.

| | | Test n° 7 | Test n° 8 | Test n° 9 | Test n° 10 |
|---|---|---|---|---|---|
| Viscosities | | (Prior Art) | (Invention) | (Invention) | (Invention) |
| T = 0 | μ^{I}(Po) | 2.2 | 2.4 | 2.2 | 2.4 |
| | μ^{S}(K · U) | 87 | 91 | 90 | 95 |
| | μ^{B}₁₀(mPa · s) | 4400 | 4400 | 4300 | 4600 |
| | μ^{B}₁₀₀(mPa · s) | 1590 | 1890 | 1850 | 1900 |
| T = 24 hours | μ^{I}(Po) | 2.3 | 2.5 | 2.4 | 2.4 |
| | μ^{S}(K · U) | 89 | 95 | 94 | 95 |
| | μ^{B}₁₀(mPa · s) | 4500 | 4800 | 4700 | 4800 |
| | μ^{B}₁₀₀(mPa · s) | 1630 | 2010 | 1950 | 2010 |
| T = 7 days | μ^{B}₁₀(mPa · s) | 4600 | 5200 | 5300 | 4800 |
| | μ^{B}₁₀₀(mPa · s) | 1670 | 2080 | 2120 | 1920 |

μ^{I}(Po): ICI ™ viscosity
μ^{S}(K · U): Stormer ™ viscosity
μ^{B}₁₀(mPa · s): Brookfield ™ viscosity determined at 10 revolutions per minute
μ^{B}₁₀₀(mPa · s): Brookfield ™ viscosity determined at 100 revolutions per minute

The results of table 2 b demonstrate that the paints formulated according to the invention have rheological properties which are improved relative to the prior art: an increase of the ICI™ and Stormer™ viscosities is observed. This improvement leads to an improved quality of application of the paints.

Moreover, the Brookfield™ viscosities observed for the paints according to the invention demonstrate that these formulations are stable over time.

Moreover, a number of optical properties were determined for the paints formulated according to tests n° 7 to n° 10.

The wet covering power CP of the paints formulated according to tests n° 7 to n° 10 was compared visually on contrast cards, immediately after application using a standard manual film-stretcher of thickness 150 μm of the said paints.

Tests n° 8 to n° 10 according to the invention demonstrate a covering power identical to that obtained for test n° 7, taken as a reference.

Chromatic coordinates L and b shown in table 3 belong to the chromatic space (L, a, b, Hunter) and are determined on a dry film of the paint for testing, which was previously applied using a standard manual film-stretcher with a thickness of 150 μm, on a glass plate, and then dried at 23° C. for 24 hours in a climatic enclosure at a humidity rate of 50%.

The value of the contrast ratio CR (%)=Yₙ/Y_{b} is measured on a Spectro-Pen™ spectrocolorimeter sold by the company DR LANGE™. The paint was previously applied using a standard manual film-stretcher with a thickness of 150 μm on a contrast card. The reflectance value Y_{b} on the white part of the substrate and the reflectance value Yₙ on the black part of the substrate are then measured. The value obtained in the chromatic space (X, Y, Z) is an average obtained over three measurements.

The brightness was measured on a Micro-Tri-Gloss™ reflectometer sold by the company BRANDT™ at angles equal to 60° and 85° (BS60 and BS85) according to French standard NF T 30-064. The paint was previously applied using a standard manual film-stretcher with a thickness of 150 μm on a glass plate.

TABLE 3
optical properties measured on paints formulated
according to tests n° 7 to n° 10.

| Optical | Test n° 7 | Test n° 8 | Test n° 9 | Test n° 10 |
|---|---|---|---|---|
| properties | (Prior Art) | (Invention) | (Invention) | (Invention) |
| CP | reference | identical to | identical to | identical to |
| | | reference | reference | reference |
| M | 97.4 | 97.4 | 97.5 | 97.6 |
| B | 1.1 | 1.2 | 1.1 | 1.05 |
| CR (%) | 97.1 | 97.3 | 97.2 | 97.2 |
| BS 60 | 3.8 | 3.9 | 3.7 | 3.8 |
| BS 85 | 4.0 | 4.0 | 3.9 | 4.1 |

CP: wet covering power estimated visually
M whiteness measured on a Spectro-Pen ™ spectrocolorimeter sold by the company DR LANGE ™
b: undertone measured on a Spectro-Pen ™ spectrocolorimeter sold by the company DR LANGE ™
CR (%): contrast ratio measured on a Spectro-Pen ™ spectrocolorimeter sold by the company DR LANGE ™
BS 60, BS 85: brightness measurements at 60 and 85° made on a Micro-Tri-Gloss ™ meter reflectometer sold by the company BRANDT ™, according to French standard NF T 30-064.

The results of table 3 demonstrate that the optical properties measured for the paints formulated according to the invention are equivalent to those of the prior art.

Finally, for tests n° 7 to n° 10, the pigmentary compatibility of the paints thus formulated was determined by measuring the parameter Delta E (ΔE).

The value of Delta E (ΔE) of the matt coloured aqueous formation is determined by adding, to the white base, 5% by weight of black pigment, i.e. 50 grams of black pigment (COLANYL™ Black sold by the company CLARLANT™) to 190 grams of white paint.

This test to measure ΔE is the one known to the skilled man in the art under the term “rub out”.

This test consists in applying, without shearing, using an applicator, 150 micrometers of the coloured matt or satin paint formulation for testing to a contrast card, slowly and without stress, and in waiting for 45 seconds and then in applying shearing by rubbing the still viscous paint film with the finger, for thirty seconds in any place.

After the film has dried the calorimetric difference between the sheared zone (rubbed zone) and the non-sheared zone (zone where the film has not been rubbed) determined using the Spectro-Pen™ spectrophotometer, allows evaluation (value of ΔE) of whether or not the tested paint composition has satisfactory pigmentary compatibility.

The values of ΔE determined for the coloured formulations produced from the paints corresponding to tests n° 7 to n° 10 are indicated in table 4.

TABLE 4
values of ΔE measured for different coloured formulations produced
from white bases corresponding to tests n° 7 to n° 10.

| Coloured | | | | |
|---|---|---|---|---|
| formulations | | | | |
| produced from | | | | |
| the white base | n° 7 | n° 8 | n° 9 | n° 10 |
| of the test: | (Prior Art) | (Invention) | (Invention) | (Invention) |
| ΔE | 0.6 | 0.5 | 0.4 | 0.5 |

The values of table 4 demonstrate that the pigmentary compatibility of the coloured paints formulated according to the invention remain identical to that corresponding to the test according to the prior art.

Test n° 11

This test concerns the formulation of a satin paint, according to the prior art, into which the carbonate is introduced solely in the form of a dry powder.

This is a calcium carbonate which is marble from Avenza (Italy), having a median diameter of 2 μm. It is sold by the company OMYA™ under the name Omyacarb™ 2-AV.

The thickening agent used is a polyurethane thickening agent of the HEUR type sold by the company COATEX™ under the name Coapur™ 3025.

Test n° 12

This test concerns the formulation of a satin paint, according to the invention.

The calcium carbonate is introduced in the form of an aqueous suspension according to the invention and described in test n°5.

The list of the constituents and their proportions by weight are indicated in table 5, for the paints corresponding to tests n° 11 and n° 12.

For the paints corresponding to these 2 tests, the formulator worked with a constant mass of each constituent: as such, the mass of calcium carbonate is identical for these tests, and equal to 150 g; that of the thickening agent is identical and equal to 20 g.

TABLE 5
composition of paints formulated according
to tests n° 11 and n° 12.

| | Test n° 11 | Test n° 12 |
|---|---|---|
| Constituents | (Prior Art) | (Invention) |
| Suspension of carbonate | 0 | 291.3 |
| ground according to test | | |
| n° 5 | | |
| Omyacarb ™ 2-AV | 150.0 | 0 |
| Tiona ™ RL 68 | 200.0 | 200.0 |
| Water (added in addition) | 90.0 | 0 |
| Coapur ™ 3025 | 20.0 | 14.0 |
| Coatex ™ BR3 | 4.0 | 4.0 |
| Mergal ™ K6N | 2.0 | 2.0 |
| Nopco ™ NDW | 1.0 | 1.0 |
| Butyldiglycol | 15.0 | 15.0 |
| Ammonia | 3.2 | 3.2 |
| Tego Foamex ™ 1488 | 1.0 | 1.0 |
| Texanol ™ | 15.0 | 15.0 |
| Acronal ™ 290 D | 440.0 | 440.0 |
| Total | 1000.0 | 1000.0 |

The figures designate masses by weight.
Tiona ™ RL 68 designates titanium dioxide sold by the company MILLENNIUM ™
Coatex ™ P90 is a polyacrylic dispersing agent sold by the company COATEX ™
Mergal ™ K6N is a bactericide sold by the company TROY ™
Nopco ™ NDW is an anti-foaming agent sold by the company COGNIS ™
Tego Foamex ™ 1488 is also an anti-foaming agent sold by the company TEGO CHEMIE ™
Texanol ™ is a coalescence agent sold by the company EASTMAN KODAK ™
Acronal ™ 290 D is an acrylic binder sold by the company BASF ™

The values of the ICI™, Stormer™ and Brookfield™ viscosities, measured at different times, for the paints formulated in tests n° 11 and n° 12, are summarised in table 5 b.

TABLE 5 b
viscosities measured in relation to paints formulated
according to tests n° 11 and n° 12.

| | | |
|---|---|---|
| | Test n° 11 | Test n° 12 |
| Viscosities | (Prior Art) | (Invention) |

| | | | |
|---|---|---|---|
| T = 0 | μ^{I}(Po) | 2.3 | 2.4 |
| | μ^{S}(K · U) | 94 | 96 |
| | μ^{B}₁₀(mPa · s) | 4400 | 4600 |
| | μ^{B}₁₀₀(mPa · s) | 1900 | 2010 |
| T = 24 hours | μ^{I}(Po) | 2.5 | 2.7 |
| | μ^{S}(K · U) | 103 | 107 |
| | μ^{B}₁₀(mPa · s) | 6800 | 6900 |
| | μ^{B}₁₀₀(mPa · s) | 2790 | 2930 |

μ^{I}(Po): ICI ™ viscosity
μ^{S}(K · U): Stormer ™ viscosity
μ^{B}₁₀(mPa · s): Brookfield ™ viscosity determined at 10 revolutions per minute
μ^{B}₁₀₀(mPa · s): Brookfield ™ viscosity determined at 100 revolutions per minute

The results of table 5 b demonstrate that the paint formulated according to the invention has rheological properties which are improved relative to the prior art: an increase of the ICI™ and Stormer™ viscosities is observed. This improvement leads to an improved quality of application of the paints.

Moreover, the Brookfield™ viscosities observed for the paints according to the invention demonstrate that these formulations are stable over time.

Test n° 13

This test concerns the formulation of a matt paint, according to the prior art.

A part of the calcium carbonate is introduced in the form of a dry powder: this is a calcium carbonate which is marble from Avenza, with a median diameter of 2 μm. It is sold by the company OMYA™ under the name Omyacarb™ 2-AV.

The other part is introduced in the form of an aqueous suspension of calcium carbonate which is marble from Avenza, with an initial median diameter of 10 μm. This suspension is obtained from a grinding process according to the prior art, in the presence of 0.3% by dry weight of a traditional grinding agent which is a sodium polyacrylate. The suspension obtained has a dry matter concentration equal to 75% of its total weight, and the calcium carbonate thus refined and contained in the suspension has a median diameter of 5 μm.

Test n° 14

This test concerns the formulation of a matt paint, according to the invention.

A part of the calcium carbonate is introduced in the form of a dry powder: this is a calcium carbonate which is marble from Avenza, with a median diameter of 2 μm. It is sold by the company OMYA™ under the name Omyacarb™ 2-AV.

The other part is introduced in the form of the aqueous suspension from test n° 6.

The list of the constituents and their proportions by weight are indicated in table 6, for the paints corresponding to tests 13 and 14.

For the paints corresponding to these 2 tests, the formulator worked with a constant mass of each constituent: as such, the mass of calcium carbonate is identical for these tests, and equal to 500 g; that of the binder is identical and equal to 160 g.

TABLE 6
composition of paints formulated according
to tests n° 13 and n° 14.

| | Test n° 13 | Test n° 14 |
|---|---|---|
| Constituents | (Prior Art) | (Invention) |
| Suspension of carbonate ground | 0 | 518.7 |
| according to test n° 6 | | |
| Suspension of carbonate ground | 400.0 | 0 |
| in the presence of sodium | | |
| polyacrylate (prior art) | | |
| Omyacarb ™ 2-AV | 200.0 | 200.0 |
| Tiona ™ RL 68 | 80.0 | 80.0 |
| Water (added in addition) | 113.3 | 3.3 |
| Rheo 2000 ™ | 20.0 | 11.3 |
| Mergal ™ K6N | 2.0 | 2.0 |
| Acronal ™ 290 D | 160.0 | 160.0 |
| Nopco ™ NDW | 2.0 | 2.0 |
| Butyldiglycol | 10.0 | 10.0 |
| White Spirit | 10.0 | 10.0 |
| Ammonia | 2.7 | 2.7 |
| Total | 1000.0 | 1000.0 |

The figures designate masses in grams.
ES designates the dry extract, i.e. the dry matter weight fraction as a %
Tiona ™ RL 68 designates titanium dioxide sold by the company MILLENNIUM ™
Coatex ™ P90 is a polyacrylic dispersing agent sold by the company COATEX ™
Mergal ™ K6N is a bactericide sold by the company TROY ™
Nopco ™ NDW is an anti-foaming agent sold by the company COGNIS ™
Acronal ™ 290 D is an acrylic binder sold by the company BASF ™

The values of the ICI™, Stormer™ and Brookfield™ viscosities, measured at different times, for the paints formulated in tests n°13 and n°14, are summarised in table 6 b.

TABLE 6b
viscosities measured in relation to paints formulated
according to tests n° 13 and n° 14.

| | | |
|---|---|---|
| | Test n° 13 | Test n° 14 |
| Viscosities | (Prior Art) | (Invention) |

| | | | |
|---|---|---|---|
| T = 0 | μ^{I}(P) | 2.2 | 2.8 |
| | μ^{S}(K · U) | 89 | 90 |
| | μ^{B}₁₀(mPa · s) | 5500 | 5600 |
| | μ^{B}₁₀₀(mPa · s) | 1640 | 1760 |
| T = 24 hours | μ^{I}(P) | 2.4 | 2.7 |
| | μ^{S}(K · U) | 92 | 99 |
| | μ^{B}₁₀(mPa · s) | 5500 | 6400 |
| | μ^{B}₁₀₀(mPa · s) | 1870 | 2300 |
| T = 7 days | μ^{B}₁₀(mPa · s) | 5700 | 6500 |
| | μ^{B}₁₀₀(mPa · s) | 1850 | 1950 |
| T = 1 month | μ^{B}₁₀(mPa · s) | 5700 | 6200 |
| | μ^{B}₁₀₀(mPa · s) | 1780 | 1900 |

μ^{I}(P): ICI ™ viscosity
μ^{S}(K · U): Stormer ™ viscosity
μ^{B}₁₀(mPa · s): Brookfield ™ viscosity determined at 10 revolutions per minute
μ^{B}₁₀₀(mPa · s): Brookfield ™ viscosity determined at 100 revolutions per minute

The results of table 6 b demonstrate that the paint formulated according to the invention has rheological properties which are improved relative to the prior art: an increase of the ICI™ and Stormer™ viscosities is observed. This improvement leads to an improved quality of application of the paints.

Moreover, the Brookfield™ viscosities observed for the paint according to the invention demonstrate that this formulation is stable over time.

### EXAMPLE 3

This example concerns the manufacture of aqueous suspensions of mineral matter through a grinding process according to the invention, in the presence of a thickening agent (tests n° 15 and 17 to 19), or of a blend of two thickening agents (test n° 16). It also concerns the suspensions of mineral matter thus obtained, from the grinding process according to the invention.

In tests n° 15 to 18, a calcium carbonate is used which is a marble from Avenza (Italy), and which has an initial median diameter noted d₅₀ equal to 10 μm (50% of the calcium carbonate particles have a diameter less than or equal to 10 μm). It is sold by the company OMYA™ under the name Omyacarb™ 10 AV.

In test n° 19, a precipitated calcium carbonate having an initial median diameter noted d₅₀ equal to 4.8 μm (50% of the calcium carbonate particles have a diameter less than or equal to 4.8 μm) is used. It is sold by the company SOLVAY™ under the name Socal™ P3.

The mineral matter is ground according to the process according to the invention as described in example 1.

For tests n° 15 to 19, the granulometry of the aqueous suspensions is determined, after grinding, in the same manner as that described for example 1.

Subsequently, using the same method as that used in the course of example 1, the Brookfield™ viscosities at two speeds of rotation of 10 and 100 revolutions per minute, noted respectively μ₁₀ and μ₁₀₀, are determined, at times t=0 and t=8 days after one minute's stirring.

Test n° 15

This test illustrates the invention and uses 0.25% by dry weight relative to total weight of the suspension, of an acrylic thickening agent of the ASE type sold by the company COATEX™ under the name Viscoatex™ V46. It also uses 50.0% by dry weight relative to the total weight of the suspension of calcium carbonate from Avenza, and the remainder of water.

Test n° 16

This test illustrates the invention and uses 0.25% by dry weight relative to the total weight of suspension of an acrylic thickening agent of the HASE type sold by the company COATEX™ under the name Rheo 2000™ et 0.25% by dry weight relative to the total weight of the suspension of a polyurethane thickening agent of the HEUR type sold by the company COATEX™ under the name Coapur™ 2025. It also uses 50.0% by dry weight relative to the total weight of the suspension of calcium carbonate from Avenza, and the remainder of water.

Test n° 17

This test illustrates the invention and uses 0.10% by dry weight relative to total weight of the suspension, of an acrylic thickening agent of the ASE type sold by the company COATEX™ under the name Rheo 2000™. It also uses 20.0% by dry weight relative to the total weight of the suspension of calcium carbonate from Avenza, and the remainder of water.

Test n° 18

This test illustrates the invention and uses 0.25% by dry weight relative to total weight of the suspension, of a polyether thickening agent sold by the company AQUALON™ total weight of the suspension of calcium carbonate from Avenza, and the remainder of water.

Test n° 19

This test illustrates the invention and uses 0.25% by dry weight relative to total weight of the suspension, of a polyurethane thickening agent of the HEUR type sold by the company COATEX™ under the name Coapur™ 2025. It also uses 50.0% by dry weight relative to the total weight of the suspension of precipitated calcium carbonate Socal™ P3, and the remainder of water.

The values of the median diameters d₅₀ determined after grinding, and the values of the Brookfield™ viscosities μ₁₀ and μ₁₀₀, measured after grinding at times t=0 and t=8 days after one minute's stirring, are indicated in table 7.

TABLE 7
median diameter d₅₀ after grinding, and Brookfield ™ viscosities μ₁₀
and μ₁₀₀, after grinding (at times t = 0
and t = 8 days after one minute's stirring)

| | | Invention | | | | |
|---|---|---|---|---|---|---|
| Test n° | | 15 | 16 | 17 | 18 | 19 |
| Calcium carbonate | | 50 | 50 | 20 | 50 | 50 |
| (% by dry weight) | | | | | | |
| Thickening agent | | 0.25 | 0.50 | 0.10 | 0.25 | 0.25 |
| (% by dry weight) | | | | | | |
| d₅₀ (μm) | | 5.6 | 4.9 | 2.5 | 4.3 | 2.1 |
| Viscosity | μ₁₀(mPa · s) | 160 | 50 | 40 | 800 | 1630 |
| at T = 0 | μ₁₀₀(mPa · s) | 73 | 30 | 10 | 110 | 250 |
| Viscosity | μ₁₀(mPa · s) | 110 | 45 | 40 | 760 | 3120 |
| at T = 8 | μ₁₀₀(mPa · s) | 90 | 30 | 10 | 175 | 110 |
| days | | | | | | |

The median diameters corresponding to the tests n° 15 to n° 19 demonstrate that, for the process according to the invention, the thickening agents used do indeed act as grinding aid agents, in the sense that a notable diminution of the size of the calcium carbonate particles is observed.

Finally, it is observed that each suspension obtained according to the invention is stable over time.

### EXAMPLE 4

This example illustrates the invention and concerns the manufacture of a rendering, a coating and a glue according to the invention.

Test n° 20

This test illustrates the invention and concerns the manufacture of a rendering according to the invention.

To accomplish this, a rendering is therefore produced, using the methods well known to the skilled man in the art, the composition of which is given in table 8. This test notably uses the aqueous suspension of mineral matter ground according to the invention, and obtained in the course of test n° 15.

TABLE 8
composition of a rendering formulation according to the invention

| Constituents | Weight (g) |
|---|---|
| Aqueous suspension of mineral matter according | 259.5 |
| to test n° 15 | |
| Coatex ™ P90 | 3.0 |
| Mergal ™ K6N | 2.0 |
| TiO2 RL68 | 60.0 |
| Hydrocarb ™ | 35.0 |
| Durcal ™ 130 | 110.0 |
| Rhodopas ™ DS 910 (50%) | 200.0 |
| Mono-ethylene glycol | 10.0 |
| White Spirit | 10.0 |
| Granicalcium ™ | 300.0 |
| Ammonia | 2.5 |
| Viscoatex ™ 46 | 18.0 |

Coatex ™ P90 is an acrylic dispersing agent sold by the company COATEX ™
Mergal ™ K6N is a biocide sold by the company TROY ™
TiO2 RL 68 is titanium dioxide sold by the company MILLENIUM ™
Hydrocarb ™ and Durcal ™ 130 are calcium carbonates sold by the company OMYA ™
Rhodopas ™ DS 910 is a styrene acrylic binder sold by the company RHODIA ™.
Viscoatex ™ 46 is an acrylic thickener sold by the company COATEX ™

By this means a formulation is obtained the Brookfield™ viscosities of which, measured at 1, 10 and 100 revolutions per minute (using the previously described methods), are respectively equal, at time t=0, to:

600,000 mPa·s, 115,000 mPa·s, 15,000 mPa·s.

These viscosities, measured at time t=24 hours, are respectively equal to:

400,000 mPa·s, 82,000 mPa·s, 14,500 mPa·s.

These values demonstrate that the Brookfield™ viscosities obtained are perfectly compatible with a use of the formulation according to the invention in the field of renderings.

Test n° 21

This test illustrates the invention and concerns the manufacture of a coating according to the invention.

To accomplish this, a coating is therefore produced, using the methods well known to the skilled man in the art, the composition of which is given in table 9.

This test notably uses the aqueous suspension of mineral matter ground according to the invention, and obtained in the course of test n° 15.

TABLE 9
composition of a coating formulation according to the invention

| Constituents | Weight (g) |
|---|---|
| Aqueous suspension of mineral matter according | 798.4 |
| to test n° 15 | |
| Nopco ™ NDW | 2.0 |
| Mergal ™ K6N | 0.6 |
| Myanit ™ | 120.0 |
| Acronal ™ 290D (50%) | 12.0 |
| Soda 20% | 20.0 |
| Viscoatex ™ 46 (32%) | 70.0 |

Nopco ™ NDW is an anti-foaming agent sold by the company COGNIS ™
Mergal ™ K6N is a biocide sold by the company TROY ™
Myanit ™ is a calcium carbonate sold by the company OMYA ™
Acronal ™ 290 D is a styrene acrylic binder sold by the company BASF ™

By this means a formulation is obtained the Brookfield™ viscosities of which, measured at 1, 10 and 100 revolutions per minute (using the previously described methods but in this case with a module of the Hélipath™ type), are respectively equal, at time t=0, to:

440,000 mPa·s, 59,000 mPa·s, 18,000 mPa·s.

These viscosities, measured at time t=24 hours, are respectively equal to:

570,000 mPa·s, 70,000 mPa·s, 20,500 mPa·s.

These values demonstrate that the Brookfield™ viscosities obtained are perfectly compatible with a use of the formulation according to the invention in the field of coatings.

Test n° 22

This test illustrates the invention and concerns the manufacture of a glue according to the invention.

To accomplish this, a glue is therefore produced, using the methods well known to the skilled man in the art, the composition of which is given in table 10.

This test notably uses the aqueous suspension of mineral matter ground according to the invention, and obtained in the course of test n° 15.

TABLE 10
composition of a glue formulation according to the invention

| Constituents | Weight (g) |
|---|---|
| Aqueous suspension of mineral matter according | 199.6 |
| to test n° 15 | |
| Mergal ™ K6N | 2.0 |
| Nopco ™ NDW | 1.0 |
| Rhodopas ™ DS 910 (50%) | 160.0 |
| Durcal ™ 2 | 140.0 |
| Durcal ™ 130 | 524.4 |
| Butyldiglycol | 14.0 |
| Ammonia | 10.0 |
| Viscoatex ™ 46 | 70.0 |

Nopco ™ NDW is an anti-foaming agent sold by the company COGNIS ™
Rhodopas ™ DS 910 is a styrene acrylic binder sold by the company RHODIA ™.
Durcal ™ 2 and Durcal ™ 130 are calcium carbonates sold by the company OMYA ™
Viscoatex ™ 46 is an acrylic thickener sold by the company COATEX ™

By this means a formulation is obtained the Brookfield™ viscosities of which, measured at 1, 10 and 100 revolutions per minute (using the previously described methods but in this case with a module of the Hélipath™ type), are respectively equal, at time t=0, to:

975,000 mPa·s, 210,000 mPa·s, 42,000 mPa·s.

These viscosities, measured at time t=24 hours, are respectively equal to:

1,070,000 mPa·s, 350,000 mPa·s, 94,000 mPa·s.

These values demonstrate that the Brookfield™ viscosities obtained are perfectly compatible with a use of the formulation according to the invention in the field of glues.

1: A process of manufacture of a stable suspension of mineral matter in water, comprising grinding the mineral matter in the presence of thickening agents.

2: A process according to claim 1, wherein the mineral matter is a pigment and/or a mineral filler, chosen from among natural or synthetic calcium carbonate, the dolomites, kaolin, talc, gypsum, lime, magnesia, titanium dioxide, satin white, aluminium trioxide, or again aluminium trihydroxide, mica, zinc and iron oxides, barium sulphate and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends.

3: A process according to claim 2 wherein the mineral matter is synthetic or natural calcium carbonate, titanium dioxide, or their blends.

4: A process according to claim 3 wherein the mineral matter is a synthetic calcium carbonate or a natural calcium carbonate chosen from among marble, calcite, chalk or their blends.

5: A process according to claim 1 wherein the thickening agents are chosen from among the natural thickening agents, such as the natural gums, the CMCs (Carboxymethylcelluloses) and the HECs (Hydroxyethylcelluloses) or chosen from among the synthetic thickening agents, and in particular chosen from among the synthetic gums, the acrylic thickening agents of the HASE type (Hydrophobically modified Alkali-swellable Emulsions) or ASE type (Alkali Soluble Emulsions), polyurethanes, polyethers, polyesters or those having a PVP (polyvinylpyrrolidone) base.

6: A process according to claim 5 wherein the thickening agents are chosen from among the acrylic thickening agents of the HASE type (Hydrophobically modified Alkali-swellable Emulsions) and the polyurethane thickening agents.

7: A process according to claim 1 further comprising using at least one grinding aid agent.

8: A process according to claim 1 wherein at least 15% by dry weight of mineral matter relative to the total weight of the aqueous suspension, 0.01% to 5% by dry weight of thickening agents relative to the total weight of the aqueous suspension, and 0 to 5% by dry weight of grinding aid agents relative to the total weight of the aqueous suspension are used.

9: A process according to claim 8 wherein at least 30% by dry weight of mineral matter relative to the total weight of the aqueous suspension, 0.5% to 1.5% by dry weight of thickening agents relative to the total weight of the aqueous suspension, and 0 to 2% by dry weight of grinding aid agents relative to the total weight of the aqueous suspension are used.

10: A process according to claim 9 wherein at least 50% by dry weight of mineral matter relative to the total weight of the aqueous suspension, 0.5% to 1.5% by dry weight of thickening agents relative to the total weight of the aqueous suspension, and no grinding aid agents are used.

11: An aqueous suspension of mineral matter ground in the presence of thickening agents, having a content by dry weight of mineral matter greater than or equal to 15%, and containing 0.01% to 5% by dry weight of thickening agents relative to the total weight of the aqueous suspension, and 0 to 5% by dry weight of grinding aid agents relative to the total weight of the aqueous suspension.

12: An aqueous suspension according to claim 11, having a content by dry weight of mineral matter greater than or equal to 30%, and containing 0.5% to 1.5% by dry weight of thickening agents relative to the total weight of the aqueous suspension, and 0 to 2% by dry weight of grinding aid agents relative to the total weight of the aqueous suspension.

13: An aqueous suspension according to claim 12, having a content by dry weight of mineral matter greater than or equal to 50%, and containing 0.5% to 1.5% by dry weight of thickening agent relative to the total weight of the aqueous suspension, and no grinding aid agent.

14: An aqueous suspension according to claim 11, having a granulometry such that at least 50% of the particles of mineral matter have a diameter less than or equal to 30 μm, i.e. a median diameter d₅₀ less than or equal to 30 μm.

15: An aqueous suspension according to claim 14, having a granulometry such that at least 50% of the particles of mineral matter have a diameter less than or equal to 15 μm, i.e. a median diameter d₅₀ less than or equal to 15 μm.

16: An aqueous suspension according to claim 15, having a granulometry such that at least 50% of the particles of mineral matter have a diameter less than or equal to 10 μm, i.e. a median diameter d₅₀ less than or equal to 10 μm.

17: An aqueous suspension according to claim 16, having a granulometry such that at least 50% of the particles of mineral matter have a diameter less than or equal to 5 μm, i.e. a median diameter d₅₀ less than or equal to 5 μm.

18: An aqueous suspension according to claim 11, wherein the mineral matter is a pigment and/or a mineral filler, chosen from among natural or synthetic calcium carbonate, the dolomites, kaolin, talc, gypsum, lime, magnesia, titanium dioxide, satin white, aluminium trioxide, or again aluminium trihydroxide, mica, zinc and iron oxides, barium sulphate and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends.

19: An aqueous suspension according to claim 18, wherein the mineral matter is synthetic or natural calcium carbonate, titanium dioxide, or their blends.

20: An aqueous suspension according to claim 19, wherein the mineral matter is a synthetic calcium carbonate or a natural calcium carbonate chosen from among marble, calcite, chalk or their blends.

21: An aqueous suspension according to claim 11 wherein the thickening agents are chosen from among the natural thickening agents, such as the natural gums, the CMCs (Carboxymethylcelluloses) and the HECs (Hydroxyethylcelluloses) or chosen from among the synthetic thickening agents, and in particular chosen from among the synthetic gums, the acrylic thickening agents of the HASE type (Hydrophobically modified Alkali-swellable Emulsions) or ASE type (Alkali Soluble Emulsions), polyurethanes, polyethers, polyesters or those having a PVP (polyvinylpyrrolidone) base.

22: An aqueous suspension according to claim 21 wherein the thickening agents are chosen from among the acrylic thickening agents of the HASE type (Hydrophobically modified Alkali-swellable Emulsions) and the polyurethane thickening agents.

23: A method for making aqueous paints, renderings, inks, coatings, sealants, adhesives, glues, and aqueous formulations, incorporating mineral matter, the method comprising including therein an aqueous suspensions of mineral matter ground in the presence of thickening agents according to claim 11.

24: An aqueous paint comprising an aqueous suspension of mineral matter ground in the presence of thickening agents according to claim 11.

25: A rendering comprising an aqueous suspension of mineral matter ground in the presence of thickening agents according to claim 11.

26: An ink comprising an aqueous suspension of mineral matter ground in the presence of thickening agents according to claim 11.

27: A coating comprising an aqueous of mineral matter ground in the presence of thickening agents according to claim 11.

28: A sealant comprising an aqueous suspension of mineral matter ground in the presence of thickening agents according to claim 11.

29: An adhesive comprising an aqueous suspension of mineral matter ground in the presence of thickening agents according to claim 11.

30: A glue comprising an aqueous suspension of mineral matter ground in the presence of thickening agents according to claim 11.

31: An aqueous formulation incorporating mineral matter comprising an aqueous suspension of mineral matter ground in the presence of thickening agents according to claim 11.
